(19) United States
(12) Patent Application Publication
(10) Pub. No.: US 2007/0286672 A1
(43) Pub. Date: Dec. 13, 2007

(54) Insert for High Stress Connection

(75) Inventors: Gregory K. Norwood, Houston, TX (US); Larry E. Reimert, Houston, TX (US)

Correspondence Address: Baker Botts L.L.P., One Shell Plaza, 910 Louisiana Street, Houston, TX, 77002-4995, US

(73) Assignee: Dril-Quip, Inc., Houston, TX (US)

(21) Appl. No.: 11/742,321

(22) Filed: Apr. 30, 2007

Related U.S. Application Data
(60) Provisional application No. 60/799,183, filed on May 10, 2006.

(51) Int. Cl. F16B 37/00

(52) U.S. Cl. 403/296

(57) ABSTRACT

An insert for a high stress connection. The insert has a housing having a generally cylindrical body and a flanged end with a generally cylindrical inner surface that may accommodate a bolt. The insert may have either an end cap or a thinned portion, or both. The end cap may be attached to the flanged end of the housing and sized such that the bolt does not pass through the end cap. The body may have the thinned portion.

### RELATED APPLICATION

This application claims the benefit of U.S. Provisional Patent Application Ser. No. 60/799,183, filed on May 10, 2006, which is herein incorporated by reference in its entirety as if set forth below.

### BACKGROUND

Inserts are used, in combination with locking bolts to make connections in a number of offshore applications. For example, marine drilling risers often have flanged connections which are secured with a number of threaded insert and locking bolt connections. Ends of the risers may be flanged, with eight holes for the inserts and bolts. Due to the extremely high stress on these connections, failure of a single insert may cause catastrophic stress on the remaining inserts. Therefore, the failure of a single insert may result in failure of the flanged connection, which may result in the entire line being shut down.

The current inserts have several disadvantages making them prone to failure. One drawback of the current inserts is that the load is not evenly distributed along the length of the insert. This uneven distribution of the stress is often a cause of failure in the connections. Another disadvantage of the current inserts is that the insert lips bend under stress, thereby making the insert connection unstable.

Therefore, there is a need for an insert that can better withstand high stress.

### SUMMARY

The present invention relates generally to an insert. More specifically, the present invention relates to an insert for use in high stress connections.

In one embodiment of the present invention, the insert has a housing with a generally cylindrical body and a flanged end. A cylindrical inner surface having a length and a diameter to accommodate a bolt extends through the housing. An end cap is attached to the flanged end. The end cap is sized so as to inhibit the bending of the flanged end.

In another embodiment of the present invention, the insert has a housing with a generally cylindrical body and a flanged end. A cylindrical inner surface having a length and a diameter to accommodate a bolt extends through the housing, and a portion of the body is thinned providing an even distribution of stress along the longitudinal axis of the housing.

In yet another embodiment of the present invention, the insert has a housing with a generally cylindrical body and a flanged end. A cylindrical inner surface having a length and a diameter to accommodate a bolt extends through the housing. An end cap is attached to the flanged end. The end cap is sized so as to prevent the bending of the flanged end. Additionally, a portion of the body is thinned to evenly distribute the stress in the housing.

In various other embodiments of the present invention, the end cap may be integrally attached, fixedly attached, or removeably attached to the housing. Additionally, the inner surface may be threaded.

### BRIEF DESCRIPTION OF THE DRAWINGS

FIG. 1 is a perspective view showing a number of inserts installed in a flanged riser connector in accordance with one embodiment of the present invention.

FIG. 2 is a perspective view of an insert in accordance with the prior art.

FIG. 3 is a cross-sectional view of the insert of FIG. 2.

FIG. 4 is a perspective view showing an insert in accordance with one embodiment of the present invention.

FIG. 5 is a cross-sectional view of the embodiment illustrated in FIG. 4.

FIG. 6 is a cutaway view of the embodiment illustrated in FIG. 4, showing the insert and a bolt prior to engagement.

FIG. 7 is a cutaway view of the embodiment illustrated in FIG. 4, showing the insert and a bolt after engagement.

### DETAILED DESCRIPTION

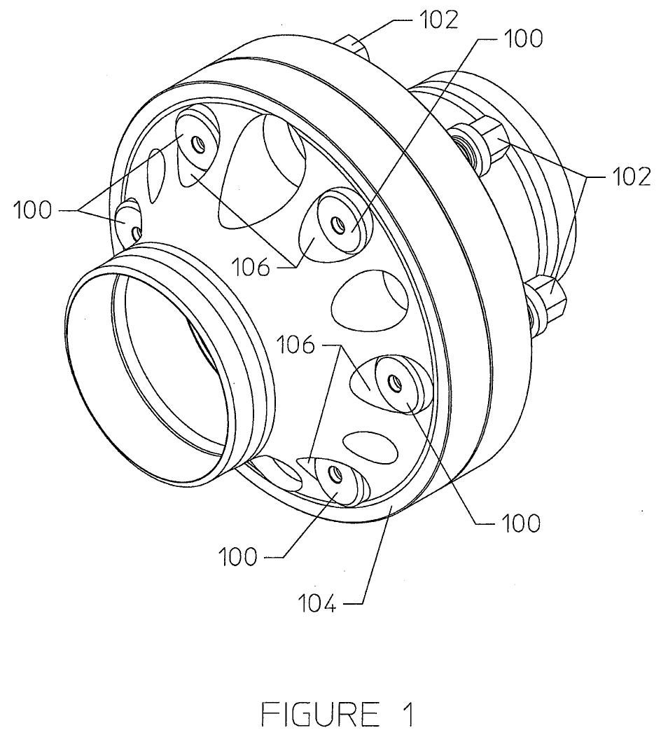

The details of the present invention will now be discussed with reference to the figures. Turning to FIG. 1, a number of inserts 100 are depicted forming connections with a number of bolts 102. Each insert 100 may couple with a respective threaded bolt 102 to secure the connection. The insert 100 and the bolt 102 may be secured from opposite sides of a flange 104 to form the connection. The insert 100 may fit in a recess 106 within the flange 104. The connection may connect marine or drilling risers, wellheads, surface equipment, or any other high stress connection, such as a flanged connection or a bolted connection or any preloaded connection.

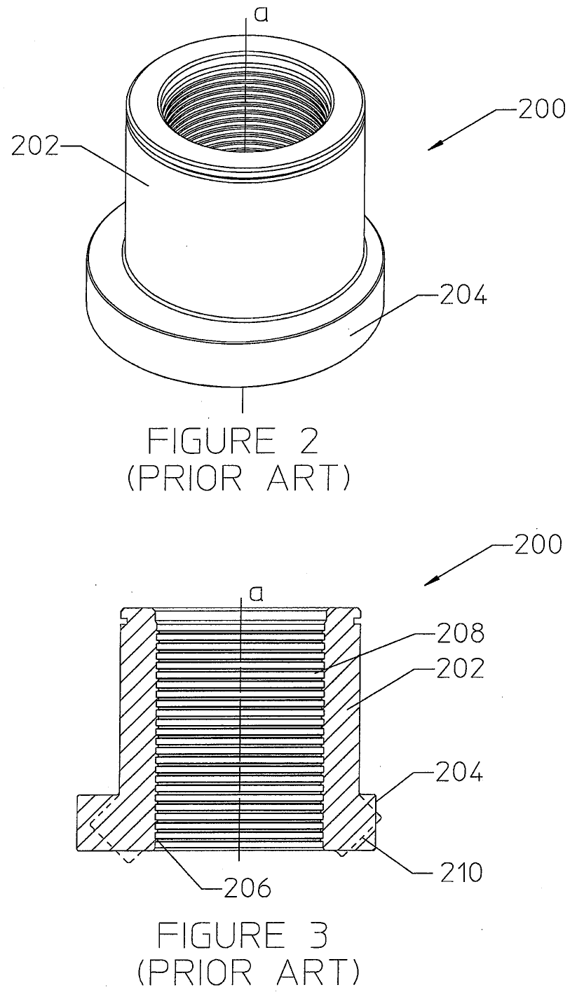

Referring to FIG. 2, a perspective view of an insert 200 in accordance with the prior art is shown. The insert 200 comprises a cylindrical body 202 with a lip 204 at one end. FIG. 3 depicts a cross-sectional view of the insert of FIG. 2. A cylindrical inner surface 206 extends through the body 202 and the lip 204, such that a bolt 102 can fit within the housing 202 upon assembly. However, the prior art insert 200 suffers from at least two major flaws. First, there is an uneven distribution of stress on the cylindrical body 202 along its longitudinal axis a. As a result, the cylindrical body 202 is subject to a higher stress at its top portion 208 with the stress decreasing along the length of the body 202 towards the lip portion 204. This uneven stress distribution is one of the major causes of insert failure. Secondly, the loading stress exerted on the lip 204 forces the lip 204 to bend outwards as shown by the dotted lines 210. This deformation of the insert 200 is another major cause of insert failure.

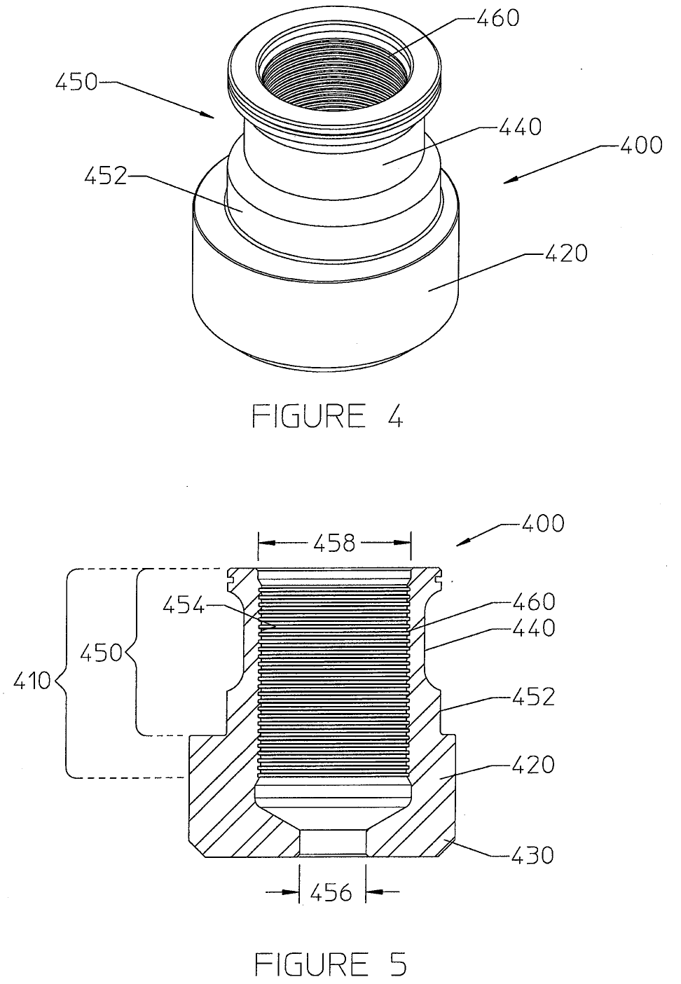

Shown in FIG. 4 is a perspective view showing an insert 400 in accordance with one embodiment of the present invention. A cross-sectional view of the insert 400 is depicted in more detail in FIG. 5. Similar to previous inserts, the insert 400 shown has a housing with a generally cylindrical body 450 and a widened portion, or a flanged end 420. However, the embodied insert 400 also includes an end cap 430 and a thinned portion 440. The insert 400 may alternatively have only one or the other, instead of both the end cap 430 and the thinned portion 440.

The body 450 may be generally cylindrical and attached to the flanged end 420, which may also be generally cylindrical. Together, the body 450 and the flanged end 420 form the housing 410. A generally cylindrical inner surface 454 may extend through both the body 450 and the flanged end 420, such that the bolt 102 can fit within the housing 410 upon assembly. The inner surface 454 may be threaded and have a length and diameter similar to that of the bolt 102, such that the housing 410 may completely accept the bolt 102. The flanged end 420 and the body 450 may have different centerlines, such that the flanged end 420 may act as a torquing device upon installation. However, the flanged end 420 and the body 450 may alternatively have the same centerline. In other words, the flanged end 420 and the body 450 may be eccentric or non-eccentric. In an exemplary embodiment the housing 410 may be made of a low alloy material, a corrosive resistant alloy, or any high strength medium.

The end cap 430 provides extra material, which can reduce stress at a critical point where the flanged end 420 meets the body 450. Specifically, because of the addition of the extra material provided by the end cap 430, the flanged end 420 can withstand a much higher stress without bending as was the case with the prior art. By preventing the flanged end 420 from bending, the insert 400 of the present invention is much less likely to fail under stress.

The end cap 430 may be attached to the flanged end 420 in a number of different ways. The end cap 430 is desirably integrally formed with the rest of the housing 410. However, the end cap 430 may alternatively be fixedly attached to the housing 410, or it may be removeably attached to the housing 410. The end cap 430 is sized and shaped such that the bolt 102 will not pass through the end cap 430. The end cap 430 may be completely closed (not shown), such that the bolt 102 may not enter the end cap 430 at all. Alternatively, the end cap 430 may be closed at one end (not shown), such that the bolt 102 could enter, but not exit the closed end. In yet another embodiment, as shown in FIG. 5, the end cap 430 may have an end inner diameter 456 that is smaller than an inner diameter 458 of the body 450. This arrangement physically prevents the bolt 102 from passing through the end cap 430 and also allows fluid to pass through the insert 400 thereby preventing potentially corrosive substances from getting trapped within the insert. In addition to physically blocking the bolt 102 from passing through the end cap 430, other methods may be used to prevent the bolt 102 from passing through. For example, the end cap 430 may not have threads, or it may have a length that extends beyond the range of the bolt 102. The end cap 430 may be made of a low alloy material, a corrosive resistant alloy, or any high strength medium.

The body 450 may have a thinned portion 440, as shown in FIG. 5. The thinned portion 440 provides a reduced mass in at least a portion of the body 450, which can reduce stress at a critical point present at a proximal end 460 of the threaded portion of the inner surface 454 of the body 450. Indeed, the reduced mass in this region makes the body 450 more elastic and thus less rigid. In doing so, it relieves stresses at the proximal end of the threaded portion 460. This added elasticity greatly increases the insert's 400 ability to withstand stress, thereby increasing the insert's stress capacity and fatigue life. As a result, the insert is less likely to fail making the connections more durable.

The insert 400 of the present invention is desirably readily interchangeable with other inserts. Therefore, the insert 400 may be sized such that it fits within standard recesses in standard connections. Additionally, the insert 400 may fit standard bolts in any of a number of typical connections. Thus, the insert 400 can be used both as a retrofit to existing marine risers and the like or alternatively can be used in new devices.

Numerous inserts 400 may be used to form a flanged connection between two or more drilling risers (not shown). Inserts 400 may be used throughout a drilling riser system (not shown) to provide increased stress resistance throughout the system.

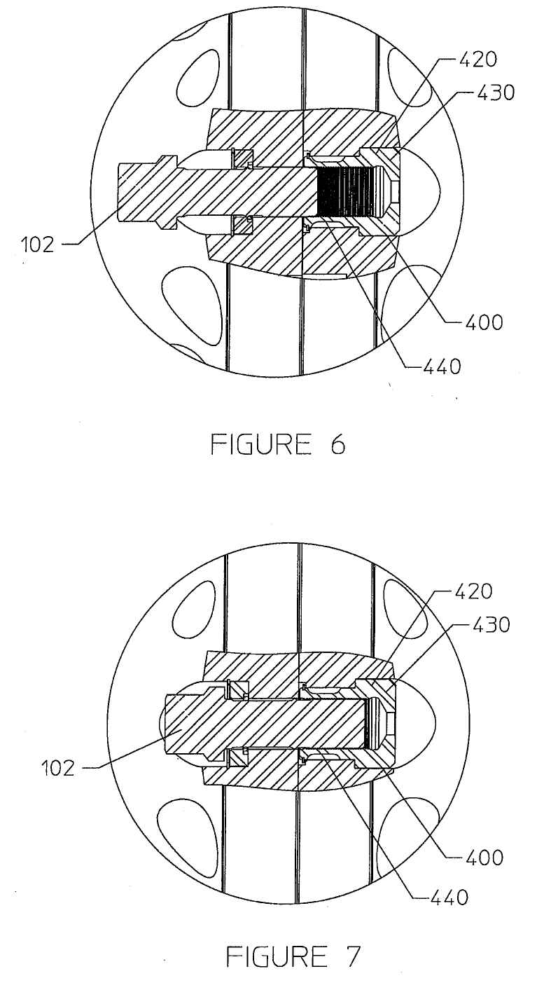

Shown in FIG. 6 is a bolt 102 and an insert 400 in accordance with an embodiment of the present invention prior to engagement. FIG. 7 depicts the bolt 102 and the insert 400 after engagement. As discussed above, the addition of one or both of the thinned portion 430 and the end cap 430 improves the insert's 400 stress capacity and fatigue life, making the connections more durable and stable.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Indeed, the inserts according to the present invention are not limited to the specific applications identified herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee.

What is claimed is:

1. An insert that fits within a recess in a bolted connection, the insert comprising:
a housing having a generally cylindrical body defined by a flanged end, and a generally cylindrical inner surface extending therethrough, the inner surface having a length and a diameter to accommodate a bolt; and
an end cap attached to the flanged end of the housing, wherein the end cap inhibits bending of the flanged end.

2. The insert of claim 1, wherein the end cap is integrally attached to the housing.

3. The insert of claim 1, wherein the end cap is fixedly attached to the housing.

4. The insert of claim 1, wherein the end cap is removeably attached to the housing.

5. The insert of claim 1, wherein the inner surface is threaded.

6. The insert of claim 1, wherein the insert is interchangeable with other inserts.

7. An insert that fits within a recess in a bolted connection, the insert comprising:
a housing having a generally cylindrical body defined by a thinned portion, a flanged end, and a generally cylindrical inner surface extending therethrough, the inner surface having a length and a diameter to accommodate a bolt,
wherein the thinned portion distributes stress substantially evenly along a longitudinal axis of the housing.

8. The insert of claim 7, wherein the end cap is integrally attached to the housing.

9. The insert of claim 7, wherein the end cap is fixedly attached to the housing.

10. The insert of claim 7, wherein the end cap is removeably attached to the housing.

11. The insert of claim 7, wherein the inner surface is threaded.

12. The insert of claim 7, wherein the insert is interchangeable with other inserts.

13. An insert that fits within a recess in a bolted connection, the insert comprising:
a housing having a generally cylindrical body defined by a thinned portion, a flanged end, and a generally cylindrical inner surface extending therethrough, the inner surface having a length and a diameter to accommodate a bolt; and
an end cap attached to the flanged end of the housing,
wherein the thinned portion of the housing distributes stress substantially evenly along a longitudinal axis of the housing and the end cap inhibits bending of the flanged end.

14. The insert of claim 13, wherein the inner surface is threaded.

15. The insert of claim 13, wherein the insert is interchangeable with other inserts.

16. The insert of claim 13, wherein the flanged end is eccentric with the generally cylindrical body.

17. The insert of claim 13, wherein the flanged end is non-eccentric with the generally cylindrical body.

18. The insert of claim 13, wherein the end cap is integrally attached to the housing.

19. The insert of claim 13, wherein the end cap is fixedly attached to the housing.

20. The insert of claim 13, wherein the end cap is removeably attached to the housing.
